(19) United States
(12) Patent Application Publication
(10) Pub. No.: US 2025/0285060 A1
(43) Pub. Date: Sep. 11, 2025

(54) Machine-Learned Action Prediction in a Database Environment

(71) Applicant: ZenPayroll, Inc., San Francisco, CA (US)

(72) Inventor: Kevin Lawver, Savannah, GA (US)

(21) Appl. No.: 18/599,918

(22) Filed: Mar. 8, 2024

(51) Int. Cl. G06Q 10/0637; G06Q 10/105

(52) U.S. Cl. CPC G06Q 10/06375; G06Q 10/105

(57) ABSTRACT

A database system accesses historical data, including characteristics of employees before their departure from past employers. It then generates a normalized training set based on this data and geographic details of each entity. Using this set, the system trains a neural network to forecast employee exits from current employers. The system applies this model to predict the departure dates for specific employees from a target company. The system updates the training set with both predicted and actual departure dates, improving the neural network through a second stage of retraining.

### BACKGROUND

This disclosure relates generally to database systems, and more specifically to training and applying machine-learned models in a database system.

As businesses expand organically, the focus often lies on scaling operations, enhancing product or service offerings, and tapping into new markets. However, this intense focus on growth and operational scalability can inadvertently lead to oversight in other critical areas, particularly in human resources management. Busy managers might not allocate sufficient time or resources to ensure that their compensation or treatment strategies are aligned with industry standards and are equitable across the organization.

The issue of equitable compensation or treatment is crucial for several reasons. First, it impacts employee satisfaction and morale. Employees who feel underpaid or recognize a disparity in compensation or treatment compared to their peers are more likely to be disengaged and less productive. Second, compensation that is not competitive with market rates poses a significant risk of employee turnover. Talented employees, aware of their market value, may seek opportunities elsewhere if they believe their current employer does not adequately recognize their worth.

This risk is particularly acute in competitive industries where skilled professionals are in high demand. Losing key employees can be detrimental to a growing business, as it may lead to disruptions in operations, loss of institutional knowledge, and additional costs associated with recruiting and training new staff.

### SUMMARY

Embodiments described herein address the problem mentioned above by utilizing machine learning to predict the departure dates of target employees. In some embodiments, a database system accesses a set of historical employee data, which includes characteristics of employees prior to their departure from an employer. The database system generates a training set of data by performing one or more normalization operations on the accessed set of historical employee data. In some embodiments, at least one normalization operation is based on the geographic characteristics of each historical employee. The system then trains a neural network in a first stage using the training set of data to predict when an employee will depart from their current employer. It applies the trained neural network to a set of target employees to predict the departure dates of these employees from a target employer. The database system updates the training set of data to include both the predicted and actual departure dates of the target employees, thereby enhancing the neural network's accuracy by retraining it in a second stage with the updated training set of data.

In some embodiments, the database system also generates one or more recommendations for the target employer to prevent the departure of target employees. These recommendations may include, but are not limited to, a pay raise, a promotion, and/or an adjustment of workload.

In some embodiments, the neural network is further trained to identify pay disparities among employees performing similar roles. The system may then identify a subset of target employees who are likely to depart from the target employer within a specified time threshold, based on the identified pay disparities.

In some embodiments, the neural network is also trained to identify overall disparities in absenteeism, overtime, or pay of entities of the target employer compared with those of other employers. In some embodiments, the neural network determines an employee churn rate of the target employer based on the identified overall disparities. In some embodiments, the system determines whether the employee churn rate of the target employer exceeds a certain threshold and generates one or more recommendations for the target employer to reduce the churn rate.

In some embodiments, the neural network is also trained to determine a trend in employee behavior over a period of time. For example, the trend may include, but is not limited to, absenteeism or overtime trends over a period, such as a few months or a year. The database system may then generate one or more recommendations for the target employer to address or encourage the identified trend. In some embodiments, the neural network is further trained to identify a trend in the churn rate over a period of time. The database system may generate one or more recommendations for the target employer to address or encourage this trend.

### BRIEF DESCRIPTION OF THE DRAWINGS

The disclosed embodiments have other advantages and features which will be more readily apparent from the detailed description, the appended claims, and the accompanying figures (or drawings). A brief introduction of the figures is below.

FIG. 1 is a block diagram of a system environment in which a central database system operates, according to one or more embodiments.

FIG. 2 is a block diagram illustrating a system architecture of the central database system, according to one or more embodiments.

FIG. 3 illustrates training and applying a machine-learned model configured to determine when a target employee is likely to leave their current employer, according to one or more embodiments.

FIG. 4 illustrates training and applying a machine-learned model configured to detect disparities among employees of a target employer, according to one or more embodiments.

FIG. 5 illustrates an example method for training and applying a machine-learned model to a central database system to predict a target employee's departure time, according to one or more embodiments.

FIG. 6 illustrates an example method for training and applying a machine-learned model to a central database system to detect disparities among employees of a target employer, according to one or more embodiments.

FIG. 7 is a block diagram of an example computer suitable for use in the networked computing environment of FIG. 1.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

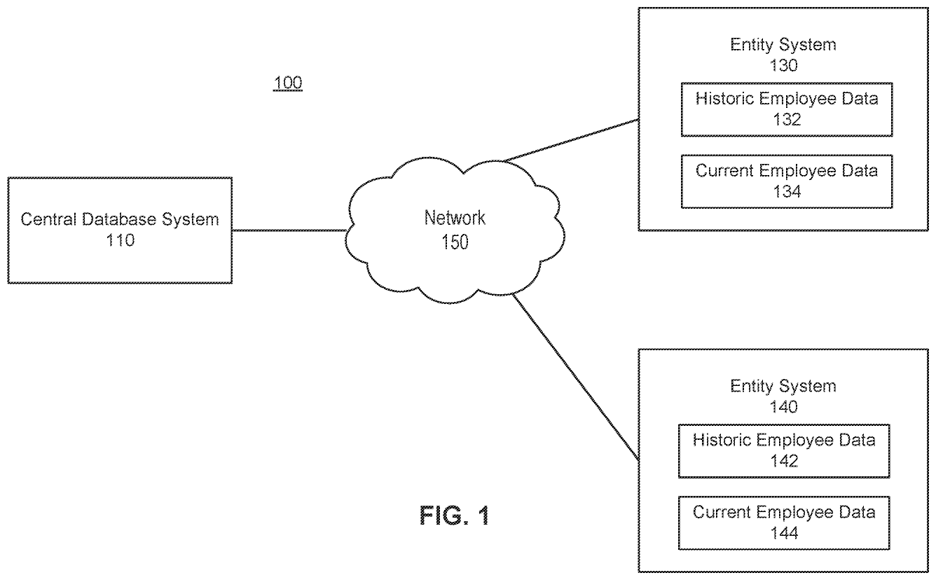

FIG. 1 is a block diagram of a system environment 100 in which a central database system operates, in accordance with an embodiment. The system environment 100 shown by FIG. 1 includes a central database system 110, one or more entity systems 130, 140, and a network 150. The system environment 100 may have alternative configurations than shown in FIG. 1, including for example different, fewer, or additional components.

The central database system 110 is, in some embodiments, a human resources management system configured to receive and store information associated with one or more entities. The one or more entities may have their corresponding entity systems 130 and 140, which are configured to communicate with the central database system 110 via the network 150. Each entity may be an institution (e.g., a corporation, a partnership, a law firm, an educational institution, an organization, etc.) that employs and/or associates with one or more individuals. Hereinafter, the institutions are also referred to as employers, and the individuals are also referred to as employees. The central database system 110 obtains, stores, or has access to information describing these employees as well as relationships between the employees and each of the employers from the entity systems 130, 140. For example, such information may include information about an employee's hiring date, employment level, position, title, geographic information, salary, benefits, tax status, contact information, performance information, attendance and timekeeping information, skills and qualifications information, and so on. Such information may also include characteristics describing both the employers corresponding to the entity system 130 and 140. Characteristics include, for example, information relating to an employer's size, type, industry, tax status, domicile, incorporation and/or formation, management personnel, customer base, as well as actions performed by the employers or by employees associated with the employers, resources used by the employers or employees associated with the employers, and issues encountered by the employers or employees associated with the employers. The employees may be historical employees and current employees, and the data includes data related to historical employee data 132, 142 and current employee data 134, 144.

The central database system 110 may generate a training set of data by performing one or more normalization operations on the accessed set of historical employee data 132, 142. In some embodiments, the one or more normalization operations are based on one or more geographic characteristics of each historical employee. The central database system 110 trains and applies machine-learned models using these stored characteristics to predict when an employee will depart from a current employer.

In the context of human resource management, considering the geographic characteristics of employees is advantageous for the development of equitable compensation strategies for several reasons. First, the cost of living can vary significantly between different geographic areas. For example, employees living in urban areas often face higher housing, transportation, and general living expenses compared to those in rural areas. By comparing employees based on geographic areas, entities can adjust salaries to ensure that employees have a comparable standard of living regardless of their locations. Further, the market rate for a particular role can differ geographically due to supply and demand dynamics. In regions with a high demand for certain skills but a low supply of qualified professionals, salaries might be higher. Comparing employees geographically allows entities to offer competitive salaries that attract and retain talent. Additionally, some regions have specific legal requirements related to employment practices, including minimum wage laws, overtime pay, and benefits. Geographic comparison ensures that entities comply with these local regulations, thereby considering added legal and/or business costs in those regions. With the rise of remote work, understanding geographic differences is beneficial for developing policies that are fair and effective across different locations.

In some embodiments, the one or more normalization operations are also based on industries. It is advantageous to also consider industry characteristics of employees for development of equitable compensation strategies. Employees in different industries acquire specialized skills and knowledge that are unique to their fields. For example, skills crucial in the technology sector, like coding or cybersecurity, are different from those valued in the healthcare industry, such as clinical expertise or patient care. Comparing employees within the same industry allows for a more accurate assessment of an individual's expertise and contributions. Further, salary ranges and compensation packages vary significantly across industries due to factors like industry profitability, talent demand, and cost of living in areas where industries are concentrated. By comparing employees within industries, entities can ensure competitive and equitable compensation strategies that reflect industry standards. Additionally, different industries often have distinct work cultures and environments that can influence employee expectations and satisfaction. For instance, the fast-paced, project-driven culture of the tech industry contrasts with the more stable and regulated environment of the financial services sector. Also, industries respond differently to economic trends and market forces, influencing job security, growth opportunities, and the likelihood of layoffs. By comparing employees within the same industry (or related industries), entities can better understand these dynamics and their impact on workforce management.

The central database system 110 may be a server, server group or cluster (including remote servers), or other suitable computing device or system of devices. The central database system 110 may communicate with other devices, including those associated with the entity systems 130,140, via client devices over the network 150 to receive and send information about employees and employers. Examples of client devices include conventional computer systems (such as a desktop or a laptop computer, a server, a cloud computing device, and the like), mobile computing devices (such as smartphones, tablet computers, mobile devices, and the like), or any other device having computer functionality. The devices of the entity systems 130, 140, and the central database system 110 are configured to communicate via the network 150, for example using a native application executed by the devices or through an application programming interface (API) running on a native operating system of the devices, such as IOS® or ANDROID™. In another example, the devices of the entity systems 130, 140, and the central database system 110 communicate via an API running on the central database system.

The central database system 110 and the entity systems 130, 140 are configured to communicate via the network 150, which may comprise any combination of local area and/or wide area networks, using wired and/or wireless communication systems. In one embodiment, the network 150 uses standard communications technologies and/or protocols. For example, the network 150 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 150 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 150 may be represented using any suitable format, such as hypertext markup language (HTML) or extensible markup language (XML). In some embodiments, all or some of the communication links of the network 150 may be encrypted using any suitable technique or techniques.

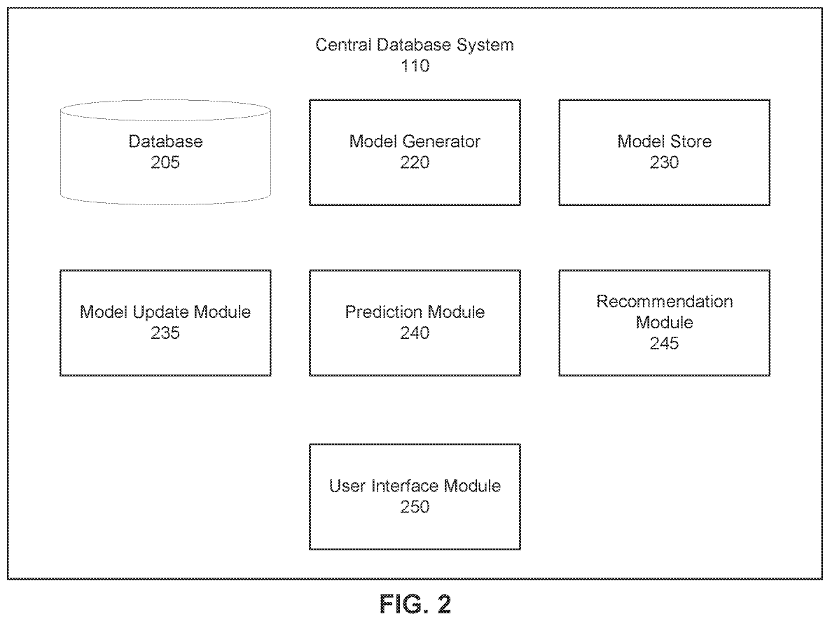

FIG. 2 is a block diagram illustrating a system architecture of the central database system 110, according to one or more embodiments. The central database system 110 of FIG. 2 includes a database 205, a model generator 220, a model store 230, a model update module 235, a prediction module 240, a recommendation module 245, and a user interface module 250. It should be noted that in other embodiments, the central database system 110 can include fewer, additional, or different components than those illustrated herein. In the embodiment of FIG. 1, the central database system 110 is different from the entity systems 130, 140. In such embodiments, the central database system 110 includes hardware (such as servers, networking equipment, databases or other storage devices, data center systems, and the like) distinct (and in some embodiments, physically remotely from) the devices associated with the entity systems 130, 140. Alternatively, in some embodiments, the central database system 110 may include or be local to the entity systems 130 and/or 140.

In some embodiments, the database 205 is configured to store information associated with the entity systems 130, 140. In some embodiments, database 205 has access to entity systems 130 and 140. In some embodiments, the information stored in the database 205 includes information gathered from the entity systems 130, 140 as they register with the central database system 110. For instance, the central database system 110 may be an enterprise software provider that provides human resources software to employers (e.g., entities, including entities associated with the entity systems 130, 140) for use with employees (e.g., employees associated with the employers). Each employer may provide information describing the characteristics of the employer and characteristics of each of the employees to the central database system 110. The database 205 stores this information about each of the employers and their employees.

In some embodiments, the database 205 may also store information describing employees associated with the employers, such as those relating to employee training, onboarding, termination, payroll, taxes, and so on. In some embodiments, the database 205 may also store information about actions performed by employees associated with the employers, and may additionally store information about resources (such as computing resources, memory, data storage, bandwidth, processing power, servers or computer systems, devices, network resources, cloud server resources, time, human-performed actions, and the like) used or required to perform such actions.

The model generator 220 trains machine-learned models. As described above, in some embodiments, the central database system 110 trains and uses a machine-learned model to predict when an employee will depart from their current employer. In some embodiments, the model generator 220 uses data stored in database 205 about the historical employees and their employers to train a machine-learned model. In some embodiments, the machine-learned model is trained to output a probability of a target employee departing their current employer within a time period. In some embodiments, the machine-learned model is trained to output a time at which the target employee will depart from their current employer. In some embodiments, the machine-learned model is trained to output recommended actions based on characteristics of the target employee and the identified departure time. In some embodiments, the model update module 235 updates the training set of data to include the predicted dates of departure of the target employee and an actual date of departure of the target employee. The model update module 235 retrains the machine-learned model based on the updated training set. The retraining may be periodically, such as daily, once a week, once, a month, etc. Alternatively, or in addition, the retraining may depend on the performance of existing machine-learned models. For example, if the accuracy of the machine-learned model is below a threshold, the model update module 235 retrains the model automatically.

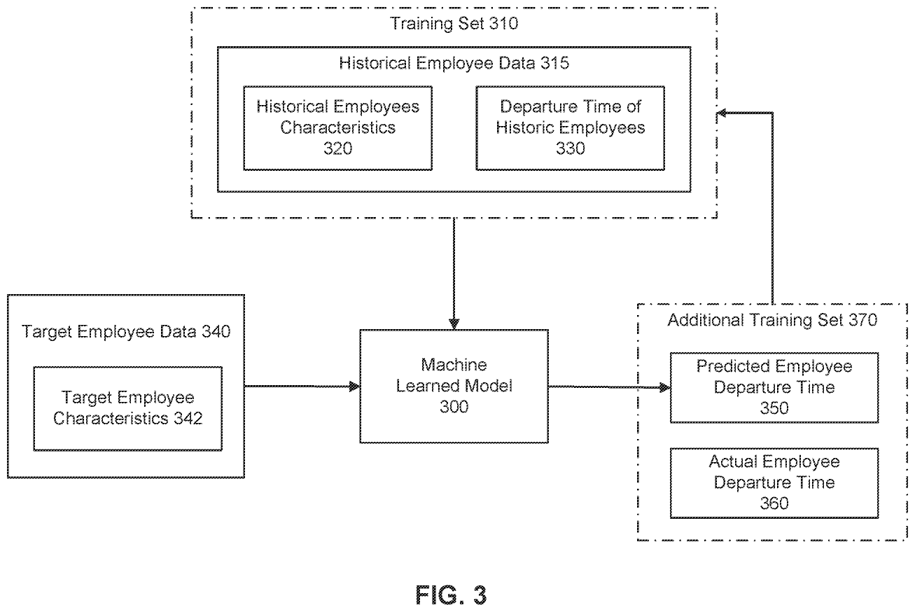

In some embodiments, the machine-learned model is trained to identify disparities in pay among employees performing similar jobs or in similar roles. In some embodiments, the machine-learned model is trained to identify a subset of employees that are likely to depart within a time threshold based on the identified disparities. In some embodiments, the machine-learned model is configured to determine a level of behavior of employees or treatment of employees at a target employer compared to that of employees at one or more other employers. In some embodiments, the machine-learned model is configured to determine an employee churn rate of the target employer based on the identified level of behavior of employees or treatment of employees at the target employer. The level of behavior of employees may include (but is not limited to) absenteeism, attendance, overtime, productivity, work quality, or attitude toward work. The level of treatment of employees may include (but is not limited to) salary, bonus, paid time off, health benefits, professional development, or recognition. Additional details about the training and application of the machine-learned models are described below, for instance with respect to FIGS. 3-6.

The model store 230 stores the machine-learned models generated by the model generator 220. In some embodiments, the model store 230 may store various versions of models as they are updated over time. In other embodiments, the model store 230 may store multiple versions of a type of model. The models can be accessed from the model store 230 by the central database system 110 or the modules of the central database system 110 as needed.

In some embodiments, the recommendation module 245 applies one or more of the models stored within the model store 230 to make one or more recommendations based on the results of the application of the models. In some embodiments, the recommendations are configured to prevent a target employee from departing from the target employer. For example, responsive to determining that a probability of an employee departing their current employer within a period of time is greater than a threshold, the recommendation module 245 recommends a pay raise (e.g., a 5% raise), a promotion, or an adjustment of workload for the employee. As another example, responsive to determining that the churn rate of an employer is greater than a threshold, the recommendation module 245 recommends certain policies or implementing a universal pay increase. Policies may include (but are not limited to) flexible work arrangements, career development, recognition and reward systems, employee engagement and inclusion activities, workplace wellness programs, etc. In some embodiments, the recommendation module 245 may automatically perform a recommended action, for instance, dispatching a thank you letter or an email to express appreciation towards target employees.

The user interface module 250 generates user interfaces for users (e.g., employees associated with the central database system 110, entity systems 130, 140) to interact with the central database system 110. The user interface module 250 receives input from users regarding information about the employee associated with entities, characteristics about the employers, actions performed by the employers, resources used by the employers to perform such actions, and issues faced by the employers. In some embodiments, the central database system 110 notifies the target employer of predicted future employee departures, recommendation actions, and the like via the user interface module 250. Users (e.g., associated with the entity systems 140) may provide feedback regarding the accuracy of the predicted future employee departures, the efficacy of the performed action, and so on. In some embodiments, the model update module 235 may include user feedback into the training set to retrain or fine-tune the machine-learned model.

FIG. 3 illustrates training and applying a machine-learned model 300 configured to determine when a target employee is likely to leave their current employer, according to one or more embodiments. As described above, the model generator 220 trains the machine-learned model 300 using a training set 310, including historical employee data 315. The historical employee data 315 includes historical employee characteristics 320 and departure times of historical employees 330. The historical employee characteristics 320 may include non-work-related characteristics and work-related characteristics. Characteristics unrelated to work may include (but are not limited to) geographical location of an employee's residence, age, gender, racial background, sexual orientation, marital status, and whether or not they have children. On the other hand, work-related characteristics may include (but are not limited to) employee behavior and treatment within the workplace. Employee behavior may include various characteristics such as absenteeism, lateness, presence at work, overtime hours, output efficiency, type of work performed, quality of work, and their overall disposition towards their duties. The way employees are treated can include characteristics like wages, bonuses, vacation time, health benefits, opportunities for career advancement, team-building retreats, and acknowledgment of their efforts.

The machine-learned model 300 takes, as input, target employee data 340. Target employee data 340 may include target employee characteristics 342, which may include categories of information similar to the historical employees, but for the target employee. In some embodiments, the historical employee characteristics 320 and the target employee characteristics 342 include time series data, which are sequences of data points listed in time order and features that could influence the timing of an employee's departure.

The model generator 220 may use one or more different types of supervised or unsupervised machine learning, or any other suitable training technique to generate and update the machine-learned model 300. In some embodiments, the model generator 220 uses one or more of linear support vector machines (linear SVM), boosting for other algorithms (e.g., AdaBoost), neural networks, logistic regression, naïve Bayes, memory-based learning, random forests, bagged trees, decision trees, boosted trees, boosted stumps, autoregressive integrated moving average (ARIMA), exponential smoothing, long-short-term memory neural networks, survival analysis models, and so on for training the machine-learned model 300. The machine-learned model 300 is trained to identify patterns or correlations between the historical employee characteristics 320 and the departure times of the historical employees 330 to identify, based on the target employee data 340, a predicted employee departure time 350. In some embodiments, the machine-learned model 300 is trained to determine whether a target employee of a target employer is likely to depart within a time frame, e.g., within 6 months, between 6 months and 12 months.

In some embodiments, the model generator 220 selects, modifies, and/or creates features from raw data related to historical employee characteristics 320 and target employee characteristics 342. For example, the raw data of the historical employee characteristics 320 may be normalized. In some embodiments, the raw data of the historical employee characteristics 320 include geographic characteristics of employees, and the normalization is based on the geographic characteristics. In some embodiments, the raw data of the historical employee characteristics 320 include industry-specific characteristics of employees, and the normalization is based on the industry-specific characteristics of employees.

In some embodiments, the model generator 220 selects a training technique among a plurality of training techniques. In some embodiments, a time series forecasting model, such as (but not limited to) ARIMA, exponential smoothing, or LSTM neural networks may be selected for predicting when a target employee is likely to depart a current employer. In some embodiments, a survival analysis model, such as (but not limited to) Cox proportional hazards model, is selected for predicting a time until a target employee will depart a current employer.

In some embodiments, a classification model is selected, where time intervals are discretized into bins, and the model is trained to predict whether a target employee is likely to leave during one of the time intervals corresponding to a particular bin. The elected model is trained on historical employee characteristics 320, learning the relationships between features and timing of employees' departure from their current employers. In some embodiments, the training includes adjusting the model's parameters so that its predictions match the observed outcomes as closely as possible.

In some embodiments, the performance of the machine-leaned model 300 is evaluated using metrics relevant to the accuracy of the prediction, such as mean absolute error for a regression model or accuracy for classification tasks. In some embodiments, the training set 310 is divided into multiple subsets. One subset is used to train the machine-learned model 300, another subset is used to evaluate accuracy of the trained model 300 to ensure that the trained model 300 can generalize well to new, unseen data.

Once the model 300 is trained and evaluated, the model 300 can be used to predict a timing of a target employee's departure. The output may be a specific time, a probability distribution over a range of times, or a hazard function indicating a probability of the target employee's departure over time.

In some embodiments, the actual employee departure time 360 may also be collected, and the predicted employee departure time 350 and actual employee departure time 360 may also be included as an additional training set 370. The model update module 235 may retrain or fine-tune the machine-learned model 300 using the additional training set 370.

In some embodiments, the historical employee data 315 and the target employee data 340 are collected from a same employer. For each employer, a separate model is trained based on its own historical employee characteristics. Alternatively, the historical employee data 315 and the target employee data 340 are collected from different employers. In some embodiments, the historical employee data 315 and the target employee data 340 are collected from employers with a same industry or related industries.

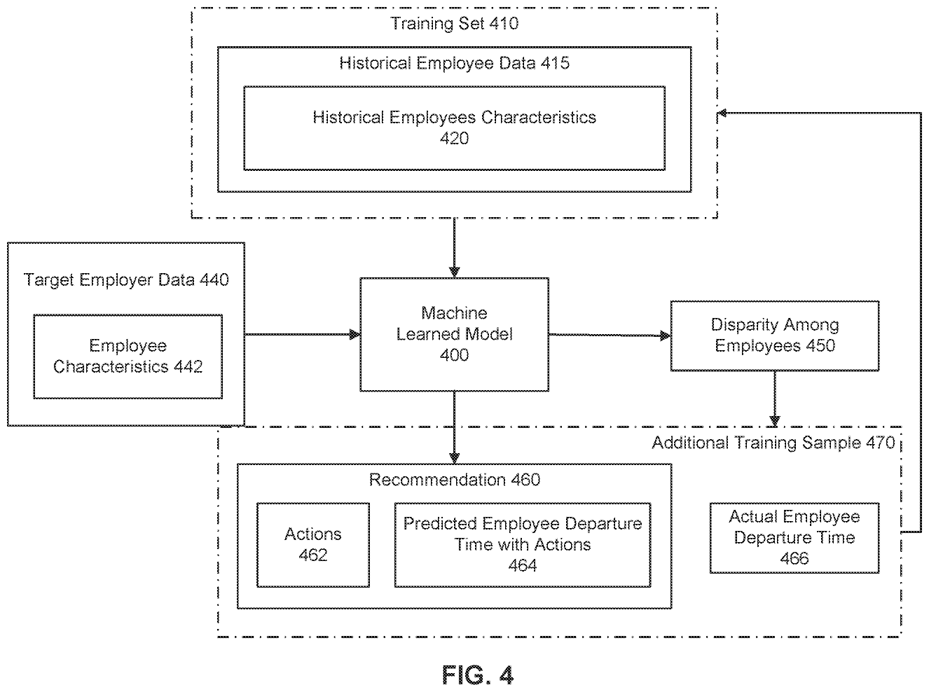

FIG. 4 illustrates training and applying a machine-learned model 400 configured to detect disparities among employees of a target employer. The machine-learned model 400 is trained over a training set 410. The training set 410 includes historical employee data 415, including historical employee characteristics 420. For a given target employer, the machine-learned model 400 is trained to detect disparities among employees of the target employer. Notably, disparities among employees in a workplace can lead to a range of negative outcomes, affecting not only individual employees but also the entity as a whole. For example, perceived or actual inequalities can significantly lower employee morale. When employees feel undervalued or discriminated against, their engagement and satisfaction with their jobs can decrease, leading to a lack of motivation and commitment. Further, disparities in treatment, compensation, or opportunities can lead to higher turnover rates. Employees who feel they are treated unfairly are more likely to seek employment elsewhere, where they believe they will be valued and treated equitably.

In some embodiments, the machine-learned model 400 is further trained to generate one or more recommendations 460 for the target employer to reduce disparities among employees of the target employer.

In some embodiments, the historical employee characteristics 420 include data that may reveal disparities, such as demographic information (e.g., age, gender, race, income level), as well as outcomes or decisions made by employers (e.g., pay raise, promotion, job responsibilities), and/or employee behavior (e.g., absenteeism, tardiness, attendance, overtime, attitude toward work). The machine-learned model 300 is trained on the training set 410 to identify patterns and relationships between features and outcomes. Various training techniques can be used, including (but not limited to) linear support vector machines (linear SVM), boosting for other algorithms (e.g., AdaBoost), neural networks, logistic regression, naïve Bayes, memory-based learning, random forests, bagged trees, decision trees, boosted trees, boosted stumps, autoregressive integrated moving average (ARIMA), exponential smoothing, long-short-term memory neural networks, survival analysis models, and so on for training the machine-learned model 400. In some embodiments, during training, biases are monitored and mitigated, such that the model can better learn from the data. Techniques for monitoring and mitigating biases may include (but are not limited to) fairness constraints or balancing datasets.

The machine-learned model 400 is trained to analyze historical employee characteristics 420 of historical employers to identify patterns, anomalies, or disparities that indicate unequal treatment among different groups. In some embodiments, the machine-learned model 400 is trained to divide employees of a target employer into groups based on a first set of characteristics (such as race, gender, a particular role, a job title) and detect disparities or unequal treatment based on a second set of characteristics (such as salary, promotion, overtime, paid time off).

In some embodiments, the machine-learned model 400 is further trained to identify disparities in pay among employees performing similar jobs or in similar roles. In some embodiments, the machine-learned model 300 is further trained to identify a subset of target employees that are likely to depart the target employer within a time threshold based on the identified disparities.

In some embodiments, the machine-learned model 400 is further trained to identify a level of behavior or treatment of employees at the target employer compared to that of employees at one or more other employers and determines an employee churn rate of the target employer based on the identified level. In some embodiments, the level of behavior of employees may include (but is not limited to) absenteeism, attendance, overtime, productivity, work quality, or attitude toward work. The level of treatment of employees may include (but is not limited to) salary, bonus, paid time off, health benefits, professional development, or recognition.

In some embodiments, responsive to detecting disparities, the machine-learned model 400 is configured to provide one or more recommendations 460. In some embodiments, the machine-learned model 400 is further configured to determine whether the employee churn rate of a target employer is greater than a threshold, and generates one or more recommendations 460 for the target employer to reduce employee churn rate. In some embodiments, the machine-learned model 400 is further trained to determine a trend in employee behavior over a period of time. In some embodiments, the machine-learned model 400 is further configured to generate one or more recommendations 460 to the target employer to remediate or encourage the trend responsive to identifying a trend in employee behavior. In some embodiments, the trend in employee behavior comprises an absenteeism trend or an overtime trend over the period of time. In some embodiments, the machine-learned model 400 is further trained to identify a trend in churn rate over a period of time. In some embodiments, the machine-learned model 400 is further configured to generate one or more recommendations 460 to the target employer to remediate or encourage the trend responsive to determining the trend.

In some embodiments, one or more recommendations 460 may include (but are not limited to) policies, targeted programs, or adjustments to decision-making processes that are related to the detected disparities. For example, policies or targeted programs may include (but are not limited to) flexible work arrangements, career development, recognition and reward systems, employee engagement and inclusion activities, workplace wellness programs, etc. In some embodiments, the one or more recommendations 460 include (but are not limited to) one or more actions 462 for specific employees. In some embodiments, the one or more actions 462 may include (but are not limited to) a pay raise, a promotion, a change in job responsibilities, or an adjustment in workload for a specific employee.

In some embodiments, the machine-learned model 400 is also configured to predict an employee departure time based on the detected disparity. In some embodiments, the machine-learned model 400 is further configured to predict an updated employee departure time of 464 with the recommended actions 462. In some embodiments, an actual employee departure time 466 is collected. The predicted employee departure time 450 and 464, recommended actions 462, and the actual employee departure time 466 may also be included as additional training sets 470. The model update module 235 is configured to retrain or fine-tune the machine-learned model 400 based on the additional training sets 470.

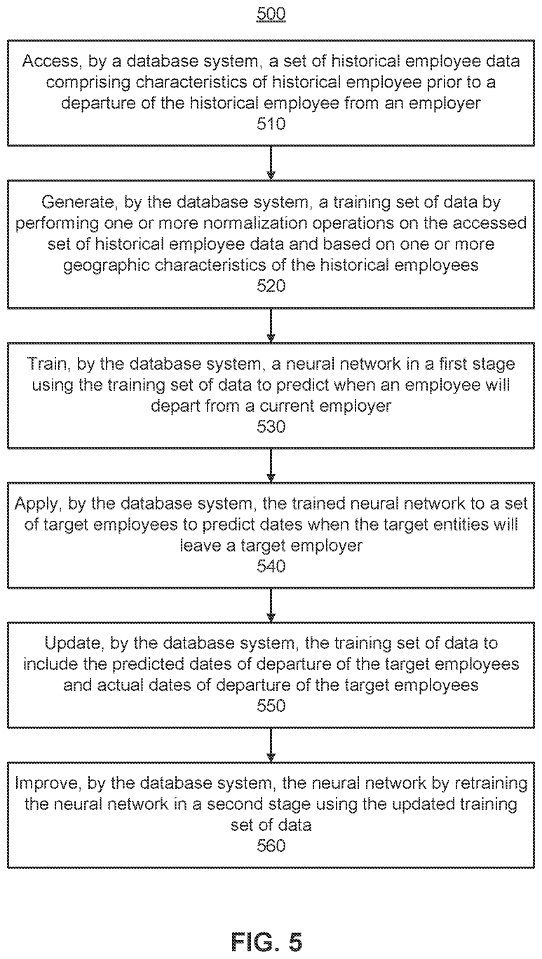

FIG. 5 illustrates an example method 500 for training and applying a machine-learned model to a central database system to predict a target employee's departure time, according to one or more embodiments. It should be noted that in other embodiments, the process of FIG. 5 can include fewer, additional, or different steps than those described herein. The method 500 may be performed at a central database system (e.g., the central database system 110), or any computing system that has access to historical employee data and target employee data.

A central database system (e.g., the central database system 110) access 510 a set of historical employee data. The historical employee data includes characteristics of historical employees prior to departure from their past employers. The characteristics of historical employees include non-work-related characteristics and work-related characteristics. Characteristics unrelated to work may include (but are not limited to) geographical location of an employee's residence, age, gender, racial background, sexual orientation, marital status, and whether or not they have children. On the other hand, work-related characteristics may include (but are not limited to) employee behavior and the way the employee is treated within the workplace. Employee behavior may include various characteristics such as absenteeism, lateness, presence at work, overtime hours, output efficiency, industry, type of work performed, quality of work, and their overall disposition towards their duties. The way employees are treated can include characteristics like wages, bonuses, vacation time, health benefits, opportunities for career advancement, team-building retreats, and acknowledgment of their efforts.

The central database system generates 520 a training set of data by performing one or more normalization operations on the accessed set of historical employee data. In some embodiments, the normalization is further based on one or more geographic characteristics of the historical employees. In some embodiments, the normalization is further based on industry or type of work performed.

The central database system trains 530 a neural network in a first stage using the training set of data to predict when an employee will depart from a current employer. Alternatively, or in addition, the neural network is trained to predict a probability of the employee departing from the current employer within one of a plurality of time intervals.

The central database system applies 540, the trained neural network, to a set of target employees to predict dates when the target employees will leave a target employer. In some embodiments, for a given target employer, the trained neural network is applied to each of the employees of the target employer to predict a departure date of the corresponding employee. Alternatively, for a given target employer, the trained neural network is applied to a subset of employees of the target employer to predict a departure date of the corresponding employee. In some embodiments, the subset of employees may be selected based on their performance. For example, this subset may be selected to include employees who are recognized for their high performance or low performance.

The central database system updates 550 the training set of data to include the predicted date of departure of the target employees and actual date of departure of the target employees. The central database system improves 560 the neural network by retraining the neural network in a second stage using the updated training set of data. For example, the machine-learned model is applied to a target employee and predicts a first departure date for the employee. Later, the target employee departs their employer at a second departure date. The central database system may compare the first departure date and the second departure date to determine a difference and cause the machine-learned model to be retrained and adjusted based on the difference.

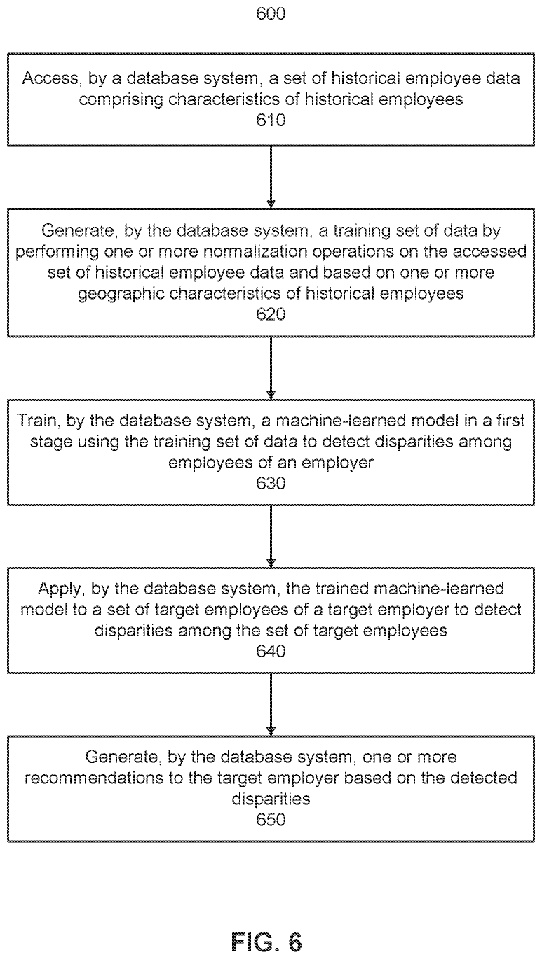

FIG. 6 illustrates an example method 600 for training and applying a machine-learned model to a central database system to detect disparities among employees of a target employer, according to one or more embodiments. It should be noted that in other embodiments, the process of FIG. 6 can include fewer, additional, or different steps than those described herein. The method 600 may be performed at a central database system (e.g., the central database system 110), or any computing system that has access to historical employee data and target employee data.

The central database system (e.g., the central database system 110) accesses 610, a set of historical employee data. The historical employee data includes characteristics of historical employees. Similar to the method 500 of FIG. 5, the historical employee data may include non-work-related characteristics and work-related characteristics.

The central database system generates 620 a training set of data by performing one or more normalization operations on the accessed set of historical employee data. In some embodiments, the normalization operations are further based on one or more geographic characteristics of historical employees. In some embodiments, the normalization operations are further based on industry or type of work performed.

The central database system trains 630, a machine-learned model, in the first stage using the training set of data to detect disparities in employees among employees of an employer. In some embodiments, the machine-learned model is trained to analyze historical employee characteristics of historical employers to identify patterns, anomalies, and/or disparities that indicate unequal treatment among different groups. In some embodiments, the machine-learned model 400 is trained to divide employees of a target employer into groups based on a first set of characteristics (such as race, gender, a particular role, a job title) and detect disparities or unequal treatment based on a second set of characteristics (such as salary, promotion, overtime, paid time off).

The central database system applies 640 the trained machine-learned model to a set of target employees of a target employer to detect disparities among the set of target employees. In some embodiments, for a given target employer, the trained machine-learned model is applied to all the employees of the target employer to detect disparities among the employees. In some embodiments, the detected disparities may include disparities in pay among employees performing similar jobs or in similar roles. Alternatively, or in addition, the detected disparities may include disparities in promotion or pay among employees of different races or genders. In some embodiments, the machine-learned model is further trained to determine a churn rate based on the detected disparities. In some embodiments, the machine-learned model is further trained to identify employees who are treated unfairly. In some embodiments, the machine-learned model is further trained to predict a departure date for the identified employees who are treated unfairly.

The central database system generates 650 one or more recommendations to the target employer based on the detected disparities. The one or more recommendations are configured to remedy the detected disparities. In some embodiments, one or more recommendations may include (but are not limited to) policies, targeted programs, or adjustments to decision-making processes that are related to the detected disparities. For example, policies or targeted programs may include (but are not limited to) flexible work arrangements, career development, recognition and reward systems, employee engagement and inclusion activities, workplace wellness programs, etc. In some embodiments, the one or more recommendations include (but are not limited to) one or more actions for specific employees who are identified as treated unfairly. In some embodiments, the one or more actions 462 may include (but are not limited to) a pay raise, a promotion, a change in job responsibilities, or an adjustment in workload for a specific employee.

In some embodiments (both with regards to the machine-learned models described in FIG. 5 or FIG. 6 and the other machine-learned models described herein), the central database system 110 can proactively perform one or more actions in order to mitigate predicted employee departure or disparities among employees. This can include but is not limited to generating and sending a notification to a manager of a target employee, informing the possibility of the target employee's departure. This can also include generating and sending a message to the target employee, encouraging the target employee to communicate with a manager, or expressing appreciation for the target employee's work.

### Example Computing System

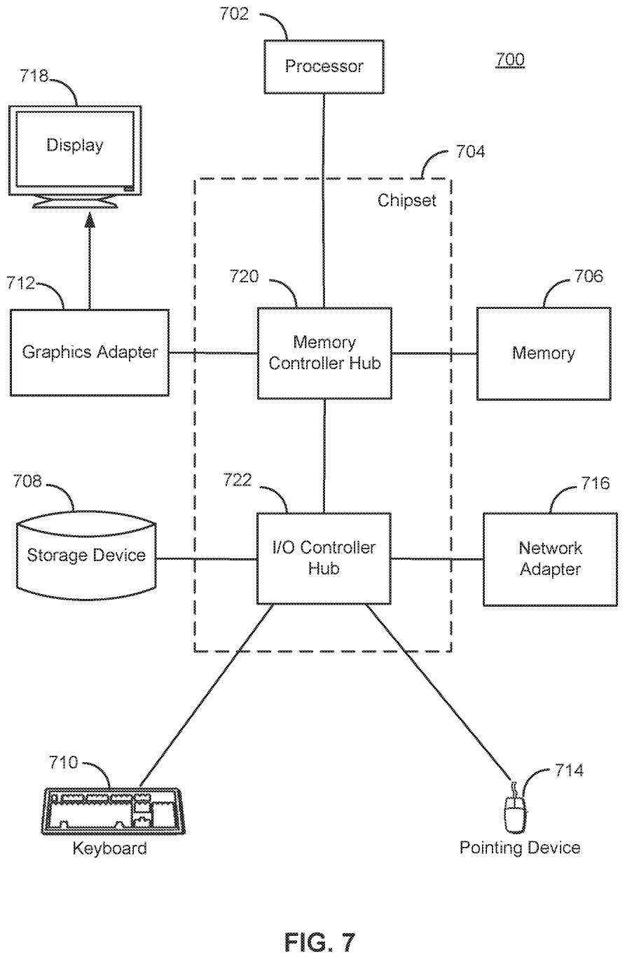

FIG. 7 is a block diagram of an example computer 700 suitable for use in the networked computing environment 100 of FIG. 1. The computer 700 is a computer system and is configured to perform specific functions as described herein. For example, the specific functions corresponding to cloud security module 314 may be configured through the computer 700.

The example computer 700 includes a processor system having one or more processors 702 coupled to a chipset 704. The chipset 704 includes a memory controller hub 720 and an input/output (I/O) controller hub 722. A memory system having one or more memories 706 and a graphics adapter 712 are coupled to the memory controller hub 720, and a display 718 is coupled to the graphics adapter 712. A storage device 708, keyboard 710, pointing device 714, and network adapter 716 are coupled to the I/O controller hub 722. Other embodiments of the computer 700 have different architectures.

In the embodiment shown in FIG. 7, the storage device 708 is a non-transitory computer-readable storage medium such as a hard drive, compact disk read-only memory (CD-ROM), DVD, or a solid-state memory device. The memory 706 holds instructions and data used by the processor 702. The pointing device 714 is a mouse, track ball, touchscreen, or other types of a pointing device and may be used in combination with the keyboard 710 (which may be an on-screen keyboard) to input data into the computer 700. The graphics adapter 712 displays images and other information on the display 718. The network adapter 716 couples the computer 700 to one or more computer networks, such as network 150.

The types of computers used by the entities and central database system 110 of FIGS. 1 through 3 can vary depending upon the embodiment and the processing power required by the entity or the central database system 110. For example, the central database system 110 might include multiple blade servers working together to provide the functionality described. Furthermore, the computers can lack some of the components described above, such as keyboards 710, graphics adapters 712, and displays 718.

### Additional Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
accessing, by a database system, a set of historical employee data comprising characteristics of historical employees prior to departure of the historical employees from past employers;
generating, by the database system, a training set of data by performing one or more normalization operations on the accessed set of historical employee data and based on one or more geographic characteristics of each historical employee;
training, by the database system, a neural network in a first stage using the training set of data to predict when an employee will depart from a target employer;
applying, by the database system, the trained neural network to a set of target employees to predict dates when the target employees will leave the target employer;
updating, by the database system, the training set of data to include the predicted dates of departure of the target employees and actual dates of departure of the target employees; and
improving, by the database system, the neural network by retraining the neural network in a second stage using the updated training set of data.

2. The method of claim 1, further comprising generating one or more recommendations for the target employer to prevent the target employees from departing the target employer.

3. The method of claim 2, wherein the one or more recommendations comprise one or more of: a pay raise, a promotion, a change in job responsibilities, or an adjustment in workload.

4. The method of claim 1, wherein the neural network is further trained to identify disparities in pay among employees performing similar jobs or in similar roles, and the method of further comprises identifying a subset of target employees that are likely to depart the target employer within a time threshold based on the identified disparities.

5. The method of claim 1, wherein the neural network is further trained to:
identify a level of behavior or treatment of employees at the target employer compared to that of employees at one or more other employers; and
determine an employee churn rate of the target employer based on the identified level.

6. The method of claim 5, wherein the level of behavior of employees comprises absenteeism, tardiness, attendance, overtime, productivity, work quality, or attitude towards work.

7. The method of claim 5, wherein the level of treatment of employees comprises salary, bonus, paid time off, health benefit, professional development, group retreat, or recognition.

8. The method of claim 5, the method further comprising:
determining whether the employee churn rate of the target employer is greater than a threshold; and
generating one or more recommendations for the target employer to reduce employee churn rate.

9. The method of claim 1, wherein the neural network is further trained to determine a trend in employee behavior over a period of time, and the method further comprises:
responsive to identifying a trend in employee behavior, generating one or more recommendations to the target employer to remediate or encourage the trend.

10. The method of claim 9, wherein the trend in employee behavior comprises an absenteeism trend or an overtime trend over the period of time.

11. The method of claim 1, wherein the neural network is further trained to identify a trend in churn rate over a period of time, and the method further comprises responsive to determining the trend in churn rate, generating one or more recommendations to the target employer to remediate or encourage the trend.

12. A non-transitory computer-readable storage medium storing executable instructions that, when executed by one or more processors, cause the one or more processors to perform operations comprising:
accessing, by a database system, a set of historical employee data comprising characteristics of historical employees prior to departure of the historical employees from past employers;
generating, by the database system, a training set of data by performing one or more normalization operations on the accessed set of historical employee data and based on one or more geographic characteristics of each historical employee;
training, by the database system, a neural network in a first stage using the training set of data to predict when an employee will depart from a target employer;
applying, by the database system, the trained neural network to a set of target employees to predict dates when the target employees will leave the target employer;
updating, by the database system, the training set of data to include the predicted dates of departure of the target employees and actual dates of departure of the target employees; and
improving, by the database system, the neural network by retraining the neural network in a second stage using the updated training set of data.

13. The non-transitory computer-readable storage medium of claim 12, the one or more processors further caused to generate one or more recommendations for the target employer to prevent the target employees from departing the target employer.

14. The non-transitory computer-readable storage medium of claim 13, wherein the one or more recommendations comprise one or more of: a pay raise, a promotion, a change in job responsibilities, or an adjustment in workload.

15. The non-transitory computer-readable storage medium of claim 12, wherein the neural network is further trained to identify disparities in pay among employees performing similar jobs or in similar roles, and the one or more processors are further caused to identify a subset of target employees that are likely to depart the target employer within a time threshold based on the identified disparities.

16. The non-transitory computer-readable storage medium of claim 12, wherein the neural network is further trained to:
identify a level of behavior or treatment of employees at the target employer compared to that of employees at one or more other employers; and
determine an employee churn rate of the target employer based on the identified level.

17. The non-transitory computer-readable storage medium of claim 16, wherein the level of behavior of employees comprises absenteeism, tardiness, attendance, overtime, productivity, work quality, or attitude towards work.

18. The non-transitory computer-readable storage medium of claim 16, wherein the level of treatment of employees comprises salary, bonus, paid time off, health benefit, professional development, group retreat, or recognition.

19. The non-transitory computer-readable storage medium of claim 16, the one or more processors further caused to:
determining whether the employee churn rate of the target employer is greater than a threshold; and
generating one or more recommendations for the target employer to reduce employee churn rate.

20. A computing system comprising:
one or more processors; and
non-transitory computer-readable storage medium storing executable instructions that, when executed by the one or more processors, cause the one or more processors to perform operations comprising:
accessing, by a database system, a set of historical employee data comprising characteristics of historical employees prior to departure of the historical employees from past employers;
generating, by the database system, a training set of data by performing one or more normalization operations on the accessed set of historical employee data and based on one or more geographic characteristics of each historical employee;
training, by the database system, a neural network in a first stage using the training set of data to predict when an employee will depart from a target employer;
applying, by the database system, the trained neural network to a set of target employees to predict dates when the target employees will leave the target employer;
updating, by the database system, the training set of data to include the predicted dates of departure of the target employees and actual dates of departure of the target employees; and
improving, by the database system, the neural network by retraining the neural network in a second stage using the updated training set of data.
